(19) United States
(12) Patent Application Publication
(10) Pub. No.: US 2015/0280841 A1
(43) Pub. Date: Oct. 1, 2015

(54) FREQUENCY AND PHASE OFFSET COMPENSATION OF MODULATED SIGNALS WITH SYMBOL TIMING RECOVERY

(71) Applicant: Olympus Corporation, Hachioji-Shi (JP)

(72) Inventors: Denis A. Gudovskiy, San Diego, CA (US); Lichung Chu, San Diego, CA (US)

(21) Appl. No.: 14/229,761

(22) Filed: Mar. 28, 2014

(51) Int. Cl. H04B 17/20; H04L 27/22; H04L 27/14; H04L 27/32

(52) U.S. Cl. CPC H04B 17/20; H04L 27/32; H04L 27/22; H04L 27/14

(57) ABSTRACT

Systems and methods are provided in which a wireless receiver can be configured to compensate frequency and phase offsets with joint symbol timing recovery of modulated signals transmitted across a channel, and it can include a transformation module configured to generate an error signal for an information signal representing the modulated signal received by the receiver. The transformation module can include a squaring module configured to square the information signal, thereby generating a squared signal, and a mixer configured to perform a complex multiplication of the squared signal by the local reference signal, and a downsampler. The transformation module can also be configured to extract and compensate frequency and phase offsets with joint symbol timing recovery.

### TECHNICAL FIELD

The disclosed technology relates generally to communication systems, and more particularly, some embodiments relate to systems and methods for frequency and phase offset compensation with symbol timing recovery for received modulated signals.

### DESCRIPTION OF THE RELATED ART

Wireless communication devices have become ubiquitous in today's society. Indeed, with the many continued advancements in communication technology, more and more devices are being introduced in both the consumer, commercial, and government sectors with advanced communications capabilities. Additionally, advances in processing power and low-power consumption technologies, as well as advances in data coding and modulation techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. Exemplary networks include the Bluetooth® communications network and various IEEE standards-based networks such as 802.11 and 802.16 communications networks, to name a few.

Additionally, tools, instrumentation, and other equipment used in a number of fields and industries have evolved to include wireless communication capabilities as part of their routine function. These communication capabilities can allow for information exchange including information such as, for example, command and control information to control the equipment; telemetry, data, or other information gathered by the equipment; status, reports, and other like “housekeeping” information; as well as other information that may be useful or necessary in the operation, use, deployment and maintenance of the equipment.

FIG. 1 is a simplified block diagram illustrating an example of a transmitter and a receiver that can be used with any of a number of wireless devices including equipment of the type mentioned above. Depending on the desired capabilities, these devices can include a transmitter, a receiver, or both (referred to as a transceiver). The transmitter receives information 122 for transmission, and may include a precoder 132, a modulator 134, an amplifier 136, and an antenna 138. Those of ordinary skill in the art will understand that a wireless transmitter may include other functionality as well. Precoder 132 can be included to, for example, precode the data to optimize performance by taking into account channel parameters or characteristics.

Modulator 134 is essentially used to receive the information to be transmitted and output a radio frequency (RF) modulated signal. Modulation is typically achieved by combining (e.g. multiplying) the information signal 122 (whether or not precoded) with a carrier wave at the desired carrier frequency. Modulation can be carried out in the analog or digital domain depending on the information to be transmitted. Examples of fundamental digital modulation techniques include phase shift keying (PSK), frequency shift keying (FSK), quadrature amplitude modulation (QAM), and variations of the foregoing, although other digital modulation techniques are known and can be used.

Amplifier 136 can be included to amplify the signal for transmission by antenna 138. Antenna 138 is included to radiate the modulated carrier signal as an electromagnetic signal across the communication channel 124 (e.g., the air). Likewise, an antenna 148 is also included on that the receiver. On the receive side, antenna 148 is used to capture the electromagnetic signal radiated across the communication channel. In embodiments using a transceiver, separate antennas can be used for transmit and receive operations or the same antenna can be used depending on the transceiver characteristics.

Continuing with a discussion of the receiver, the example basic receiver illustrated in FIG. 1 includes the antenna 148, an RF amplifier 142, a demodulator 144, and a filter 146. RF amplifier 142 amplifies the signal received by antenna 148 and provided to demodulator 144. Demodulator 144 essentially undoes the modulation that was applied by modulator 134. In other words, demodulator 144 recovers the original information-bearing signal from the modulated carrier wave. Filter 146 can be included to remove unwanted noise in the recovered information signal 123. Filtering can also be used at the front end of the receiver to improve channel selectivity. As with the transmitter, one of ordinary skill in the art will understand how additional features and components can be provided with the receiver depending on the goals and objectives of the communication system. For example, with a digital receiver, the system may include analog-to-digital conversion before demodulation, and demodulation may be performed in the digital domain. As another example, multiple downconversion steps can be performed as in, for example, a superheterodyne receiver. Still further, the incoming signal can first be down converted to an intermediate frequency (IF), the IF signal can be converted to the digital domain before downconversion to baseband.

As noted above, modulator 134 and demodulator 144 can be chosen to implement any of a number of desired modulation techniques, one of which is PSK modulation. PSK is a digital modulation technique that uses changes in phase of the carrier signal to represent the information to be transmitted. PSK modulation uses a finite number of phases to represent a unique pattern of bits or symbols. Accordingly, the incoming information stream 122 is typically operated on in groups and each group is converted into a pattern of bits (e.g., a symbol) which is represented by a particular phase of the modulation technique. At the receiver, the demodulator determines the phase of the receive signal and maps it back to the symbol it represents. In this manner, the original information can be recovered. QPSK, or quadrature phase shift keying, is a variation of PSK that uses 4 phases for modulation. With 4 phases available, QPSK can encode to information bits per symbol. PSK can be implemented using other finite numbers of phases.

FIG. 2 is a block diagram illustrating a basic QPSK Modulator and Demodulator. QPSK modulation is generally well known in the art, and those of ordinary skill in the art will understand how QPSK modulation can be implemented using alternative configurations and architectures. In the example illustrated in FIG. 2, modulator 202 includes a serial to parallel converter 216 low pass filters 232, 234, a local oscillator 242, mixers 236, 238, phase shifter 244, and summer 246. In operation, serial to parallel converter (or demultiplexer) 216 parallelizes the data into 2 separate data streams. Typically, this separates the even and odd bits. Each of the odd bits and even bits can be converted to an NRZ format and a parallel manner. The bits are sent to them in phase arm and a quadrature phase arm for modulation. Low pass filters 232, 234 are used to filter out noise from the data stream. Local oscillator 242, mixers 236, 238, phase shifter 244 are used to modulate the in-phase and quadrature phase components.

In QPSK modulation, two sinusoids (e.g., sin and cos) are used for the modulation (e.g., cos(ωt) and sin(ωt)). The signal on the in-phase arm is multiplied by the local oscillator signal-using mixer 236, and the signal on the quadrature arm is multiplied by a phase-shifted versions of the local oscillator signal at multiplexer 238. Typically, the phase shift is 90°, allowing a multiplication by cos(ωt) and sin(ωt). Accordingly, the modulation separates the original signal into two components, referred to as the I and Q channels or components. The I and Q components are orthogonal, or in quadrature, because they are separated from one another by 90 degrees, although there carrier frequencies are the same. The QPSK modulated signal is obtained by combining the signal from the in-phase and the quadrature phase arms at summer 246. Because the 2 components are orthogonal, they can be summed and transmitted simultaneously on the same channel.

The QPSK demodulator 204 includes a local oscillator 243, mixers 237, 239, phase shifter 245, low pass filters 233, 235 and decision block 249. The received QPSK modulated data stream 252 is split and provided to mixers 237, 239. Mixers 237, 239 demodulate the data to remove the carrier from the I and Q channels. This can be accomplished, for example, by multiplying the incoming signals by cos(ωt) and sin(ωt). The down converted signals are filtered by low pass filters 233, 235 and sent to decision module 249. Decision module 249 evaluate the down converted data stream to arrive at an estimate [symbol] of the originally transmitted data 222.

With coherent detection in QPSK, the receiver must know the carrier frequency and the phase to demodulate the data. Accordingly, receivers often use carrier and phase recovery techniques to accommodate this. This can be achieved, for example, by using a PLL (phase lock loop) at the receiver to lock onto the incoming carrier frequency and track the variations in frequency and phase.

Many other modulation and demodulation techniques also require some form of timing and phase estimation. For example, minimum shift keying (MSK) modulation, which also can be represented as an offset quadrature phase shift keying (O-QPSK) modulation has several attractive properties: low bandwidth relative to data rate and constant envelope for efficient power amplification. However, successful coherent demodulation of MSK-type signals on the receiver side requires symbol timing information with precise frequency and phase synchronization. Typically, transmitter and receiver oscillators have some frequency mismatch, which leads to frequency and phase offset errors. Another source of such errors could be Doppler effects, which can arise in situations where the transmitter and receiver are in motion relative to one another.

Previous solutions to phase and frequency offset compensation can be classified into several categories. One category includes a class of algorithms that use some known sequence for frequency and phase error estimation or timing synchronization i.e. they are data-aided. Data-aided algorithms may require very long known sequences to estimate offsets, especially when the receiver operates at low signal-to-noise ratio (SNR) levels.

Other classes of algorithms exploit several approaches. One approach is to estimate frequency offset in frequency domain using a Fourier transform. In another approach, fully digital non-data-aided feedforward solution was proposed. See, Mehlan, R.; Yong-En Chen; Meyr, H., “A Fully Digital Feedforward MSK Demodulator with Joint Frequency Offset and Symbol Timing Estimation for Burst Mode Mobile Radio,” Vehicular Technology, IEEE Transactions on, vol. 42, no. 4, pp. 434, 443, November 1993 (the “Mehlan Reference”). This approach relies on a special transformation mechanism to extract frequency offset and symbol timing. The system described by the Mehlan Reference finds the error signal expectation as:

E{e(m)}=(1+cos 2πε))e^{2jΔwT}

Where E{e(m)} is the expectation of the transformation function output at sampling frequency fₛ=R; T is the symbol duration time; R=1/T is the data rate; ε is the timing error relative to T, −0.5≦ε≦0.5; do is the frequency offset. As can be seen from this, the transformation estimates the timing error, ε, and the frequency offset, Δω, but does not address phase offset. Accordingly, a drawback of this approach is that it loses information about the initial phase error and it cannot extract instantaneous phase offset.

### BRIEF SUMMARY OF EMBODIMENTS

According to various embodiments of the disclosed technology solutions are presented to provide frequency and phase offset compensation. In further embodiments, the technology may be directed toward solutions for symbol timing recovery, which can be implemented to determine symbol start time. In still further embodiments, systems and methods for performing non-data-aided digital feedforward estimation techniques are provided that can be implemented to continuously estimate and compensate for frequency and phase offset errors.

According to various embodiments of the disclosed technology a radio frequency receiver can be configured to receive a modulated signal transmitted across a channel, and it can include a transformation module configured to generate a first error signal for an information signal representing the modulated signal received by the receiver. The transformation module can comprise a squaring module configured to square the information signal, thereby generating a squared signal, and a mixer configured to perform a complex multiplication of the squared signal by the local reference signal, and a downsampler configured to perform a spectrum folding of the mixed signal. In various embodiments, the radio receiver can further include a symbol timing estimator module, configured to estimate a symbol timing of the receive signal based on the error signal generated by the transform module, and to generate a symbol timing signal; a frequency offset estimator module, configured to estimate a frequency offset of the received signal based on the error signal generated by the transform module; and a phase offset estimator module configured to estimate a phase error in the received signal based on the error signal generated by the transform module.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a simplified block diagram illustrating an example of a transmitter and a receiver that can be used with wireless devices.

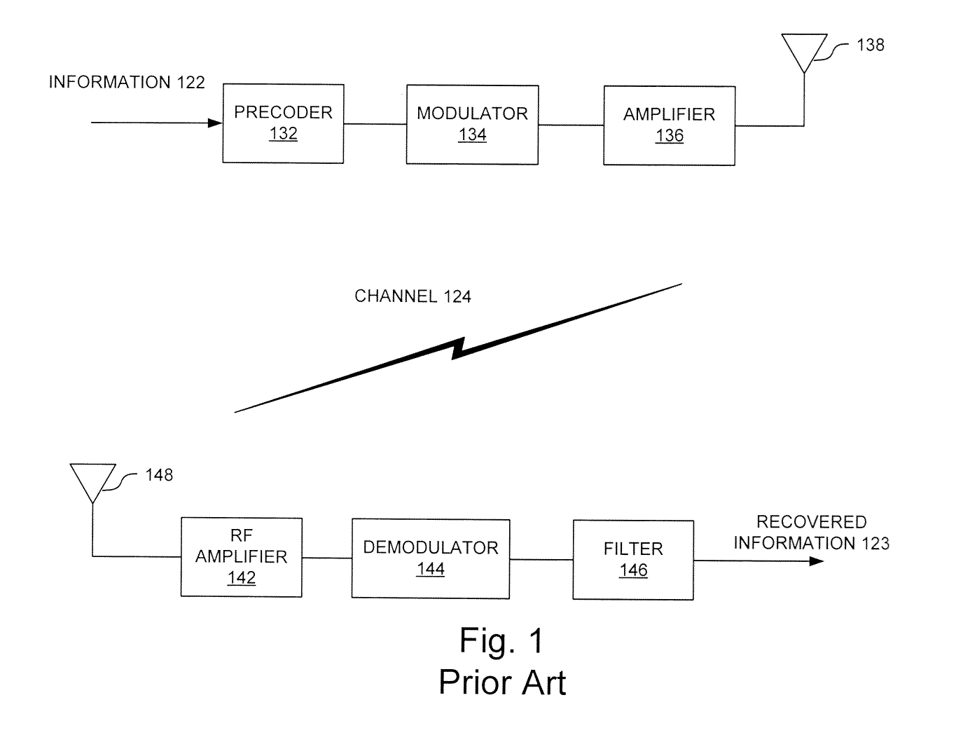

FIG. 2 is a block diagram illustrating a basic Modulator and Demodulator.

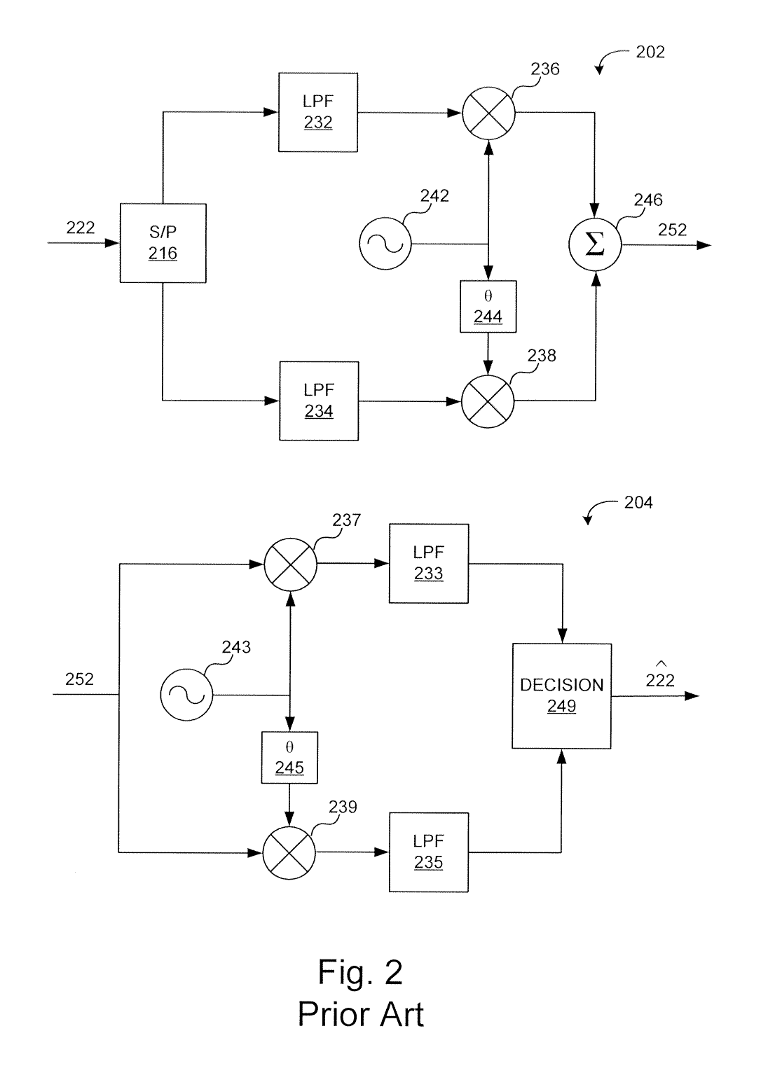

FIG. 3 is a block diagram illustrating one example of equipment with which embodiments of the technology disclosed herein can be implement.

FIG. 4 is a diagram illustrating an example of a typical digital receiver with which the technology disclosed herein can be used in accordance with various embodiments.

FIG. 5 is a flow diagram illustrating a typical operation of the receiver shown in FIG. 4.

FIG. 6 is a diagram illustrating one example implementation for frequency and phase offset compensation in accordance with one embodiment of the technology described herein.

FIG. 7 is a diagram illustrating an example transformation that can be performed in accordance with various embodiments of the technology disclosed herein.

FIG. 8, is an operational flow diagram illustrating an example of a process performed by transformation module of FIG. 7.

FIG. 9 is a diagram illustrating an example module for performing frequency estimation in accordance with various embodiments of the technology disclosed herein.

FIG. 10 is an operational flow diagram illustrating an example process for frequency estimation in accordance with various embodiments of the technology disclosed herein.

FIG. 11 is a diagram illustrating an example of a phase estimator module for estimating residual phase error in accordance with one embodiment of the technology described herein.

FIG. 12 is an operational flow diagram illustrating an example process for phase offset estimation in accordance with one embodiment of the technology described herein.

FIG. 13 is a diagram illustrating an example module for performing symbol timing recovery in accordance with various embodiments of the technology disclosed herein.

FIG. 14 is an operational flow diagram illustrating an example module for symbol timing recovery in accordance with various embodiments of the technology disclosed herein.

FIG. 15 is a block diagram illustrating an example architecture of a system for frequency and phase estimation with symbol timing recovery in accordance with one embodiment of the technology described herein.

FIG. 16 is a block diagram illustrating another example transformation in accordance with one embodiment of the technology disclosed herein.

FIG. 17 is a diagram illustrating an operational flow diagram for this transformation in accordance with one embodiment of the technology disclosed herein.

FIG. 18 is a diagram illustrating a prior art transformation described by the Mehlan Reference.

FIG. 19 illustrates an example computing module that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The technology disclosed herein in one embodiment is directed toward solutions to provide frequency and phase offset compensation. In further embodiments, the technology may be directed toward solutions for symbol timing recovery, which can be implemented to determine symbol start time. In still further embodiments, systems and methods for performing nondata-aided digital feedforward estimation techniques are provided that can be implemented to continuously estimate and compensate for frequency and phase offset errors. Slow frequency offset drift can be tracked by embodiments of the technology disclosed herein, and embodiments can be used to recover symbol timing as well. Estimation techniques can be provided that do not require any knowledge of transmitted data and may be suitable for efficient implementation in digital circuits. Symbol timing recovery solutions can be provided to reduce correlator complexity and achieve more robust performance.

According to various embodiments of the disclosed technology, a radio frequency receiver can be configured to receive a modulated signal transmitted across a channel, and it can include one or more transformation modules configured to generate a first error signal for an information signal representing the modulated signal received by the receiver. The transformation module can comprise a squaring module configured to square the information signal, thereby generating a squared signal, and a mixer configured to perform a complex multiplication of the squared signal by the local reference signal, and a downsampler configured to perform a spectrum folding of the mixed signal. In various embodiments, the radio receiver can further include a symbol timing estimator module, configured to estimate a symbol timing of the receive signal based on the error signal generated by the transform module, and to generate a symbol timing signal; a frequency offset estimator module, configured to estimate a frequency offset of the received signal based on the error signal generated by the transform module; and a phase offset estimator module configured to estimate a phase error in the received signal based on the error signal generated by the transform module. In some embodiments, the same transform module can be used to generate and supply the error signal(s) to the other modules, while in other embodiments, separate transform modules can be provided to generate the error signal(s) used by one or more of the other modules. Further, a given transform module may comprise a plurality of separate transform modules to provide the error signals to their respective corresponding module or modules. For ease of discussion and clarity of description, a separate transform module is shown in each example of the frequency estimator, phase estimator, and symbol-timing estimator.

In some embodiments, the transformation can be used to extract the symbol timing, frequency and phase offsets of an MSK modulated signal. The transformation can be applied to other modulation schemes, including various forms of continuous phase modulation (CPM) schemes.

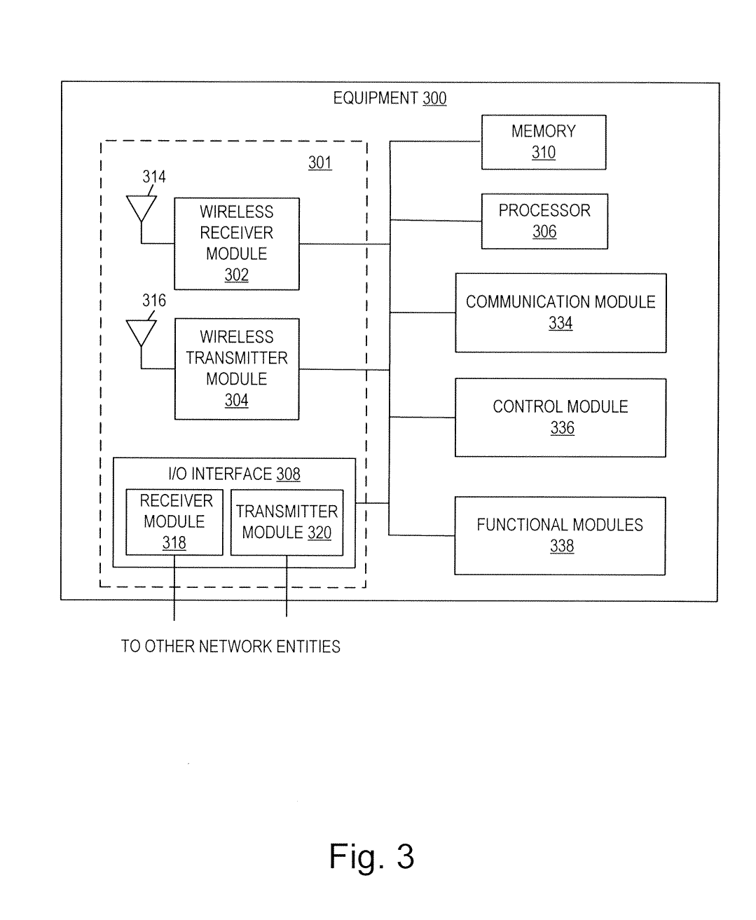

Before describing the technology in further detail, it is useful to describe an example piece of equipment with which the technology can be implemented. One such example is that of a piece of equipment both wired and wireless communication interfaces such as that shown in FIG. 3. After reading this description, one of ordinary skill in the art will appreciate that the technology disclosed herein can be used with any of a number of different devices or equipment having wireless communication capabilities.

With reference now to FIG. 3, in this example application, the example piece of equipment 300 includes a communication module 301, a processor 306 (which can include multiple processors or processing units), and memory 310 (which can include memory units or modules of different types). These components are communicatively coupled via a bus 312 over which these modules may exchange and share information and other data. Communication module 301 includes wireless receiver module 302, a wireless transmitter module 304, and an I/O interface module 308.

An antenna 316 is coupled to wireless transmitter module 304 and is used by equipment 300 to transmit radio signals wirelessly to wireless equipment with which it is connected. These outbound RF signals can include information of almost any sort that is sent by equipment 300 to other entities. For example, in the case of a multifunction peripheral (MFP) this can include files representing scanned images or documents, log information, housekeeping information, or other information sent by the MFP relating to its operation. As another example, in the case of a camera, this outbound information can include image files and related data (including metadata) sent by the camera to a computer, printer, or other device.

Antenna 314 is included and coupled to wireless receiver module 302 to allow equipment 300 to receive signals from various wireless terminals within its reception range. Received signals can include information from other equipment used for operation of equipment 300. Continuing with the above two examples, in the case of an MFP, inbound information received by wireless receiver module 302 can include, for example, files to be printed or faxed by the MFP. In the case of a camera, information received could be firmware updates, control information, or other information used by the camera.

Although two antennas are illustrated in this example, one of ordinary skill in the art will understand that various antenna and antenna configurations can be provided as can different quantities of antennas. For example, transmit and receive functions can be accommodated using a common antenna or antenna structure, or separate antennas or antenna structures can be provided for transmit and receive functions as illustrated. In addition, antenna arrays or other groups of multiple antennas or antenna elements, including combinations of passive and active elements, can be used for the transmit and receive functions. The wireless communications implemented using communication module 301 can be implemented according to a number of different wireless protocols, including standardized protocols. Examples of such standardized protocols include Bluetooth®, HiperLan, and various IEEE 802.11 communications standards, although other communication interfaces (whether or not standardized) can be implemented.

An I/O interface module 308 is provided in the illustrated example, and can be configured to couple equipment 300 to other network nodes. These can include nodes or equipment. In this example architecture, the I/O interface module 308 includes a receiver module 318 and a transmitter module 320. Communications via the I/O interface module can be wired or wireless communications, and the transmitter and receiver contained therein can include line drivers and receivers, radios, antennas or other items, as may be appropriate for the given communication interfaces. Transmitter module 320 may be configured to transmit signals that can include voice, data and other communications. These may be sent in a standard network protocol if desired. Receiver module 318 is configured to receive signals from other equipment. These signals can include voice, data and other communications from the other equipment, and can also be received in a standard network protocol if desired. In terms of the above examples of an MFP or digital camera, I/O interface 308 can provide a hardwired complementary interface to the wireless interface described above. This may be, for example, an ethernet interface, a USB interface, a FireWire interface, or other hardwired interface.

Memory 310, can be made up of one or more modules of one or more different types of memory, and in the illustrated example is configured to store data and other information 324 as well as operational instructions that may be used by the processor to operate equipment 300. The processor 306, which can be implemented as one or more cores, CPUs, DSPs, or other processor units, for example, is configured to execute instructions or routines and to use the data and information in memory 310 in conjunction with the instructions to control the operation of the equipment 300. For example, image processing routines, such as compression routines, can be stored in memory 310 and used by processor 306 to compress image files from raw files into JPEG files.

Other modules can also be provided with the equipment 300 depending on the equipment's intended function or purpose. A complete list of various additional components and modules would be too lengthy to include, however a few examples are illustrative. For example, a separate communication module 334 can also be provided for the equipment to manage and control communications received from other entities, and to direct received communications as appropriate. Communication module 334 can be configured to manage communication of various information sent to and received from other entities. Communication module 334 can be configured to manage both wired and wireless communications.

A separate control module 336 can be included to control the operation of equipment 300. For example, control module 336 can be configured to implement the features and functionality of equipment 300. Functional modules 338 can also be included to provide equipment functionality. For example, in the case of an MFP, various modules (which may include various forms of hardware and software) can be provided to perform printing, scanning, faxing, and copying operations of the device. In the case of a digital camera, functional modules 338 can include modules such as, for example, optical systems, image capture modules, image processing modules, and so on. Again, as these examples illustrate, one of ordinary skill in the art will appreciate how other modules and components can be included with equipment 300 depending on the purpose or objectives of the equipment.

Having thus described an example application, the technology disclosed herein may from time-to-time described herein in terms of this example application. Description in terms of this environment is provided to allow the various features and embodiments of the invention to be portrayed in the context of an exemplary application. After reading this description, it will become apparent to one of ordinary skill in the art how the invention can be implemented in different and alternative environments and applications.

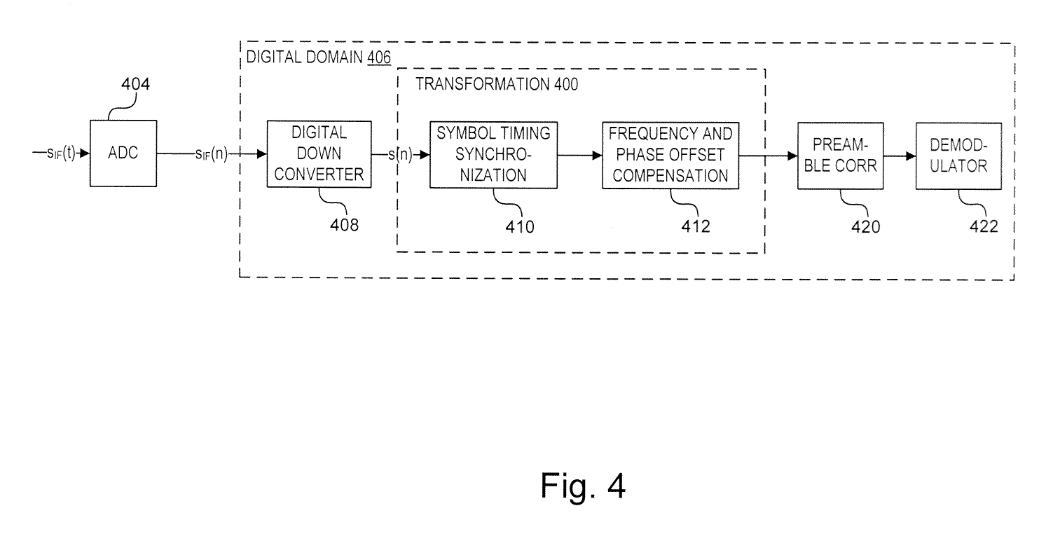

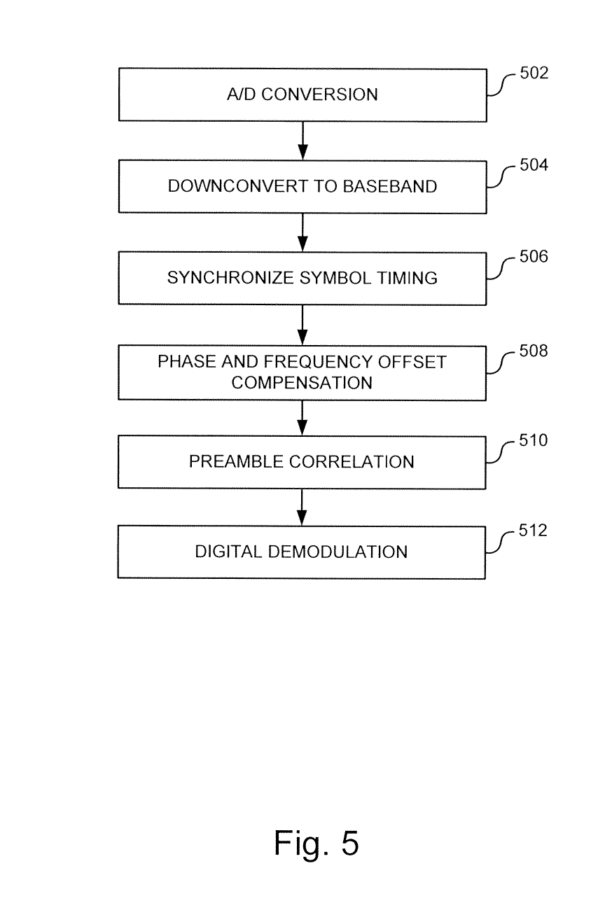

FIG. 4 is a diagram illustrating a typical digital receiver with which the technology disclosed herein can be used in accordance with various embodiments. FIG. 5 is a flow diagram illustrating a typical operation of this example receiver. Referring now to FIGS. 4 and 5, In this example, the incoming analog signal s_{IF}(t) is centered at intermediate frequency f_{IF}. Accordingly, the signal has been down converted to an intermediate frequency by an analog mixer (not shown). At operation 502, the intermediate frequency signal s_{IF}(t) is sampled by analog-to-digital converter (ADC) 404, placing the signal in the digital domain. The remainder of the processing is performed in the digital domain as indicated by the dashed box 406. At operation 504, the sampled digital signal s_{IF}(n) is downconverted into a complex baseband signal s(n). Baseband signal s(n) typically includes the information communicated from the transmitter to the receiver in the modulated signal and can thus be referred to as an information signal representing the modulated signal received by the receiver. The term information signal, however, is not limited to describing a digital baseband signal, but can refer to other information signals whether digital or analog, baseband, IF or RF, or otherwise.

Due to frequency mismatch between transmitter and receiver, s(n) has frequency offset from zero baseband frequency. That frequency offset produces an initial phase offset error and frequency offset error. These correspond to a phase and frequency offset in the modulated RF signal received by the receiver. In addition, symbol timing is not known on the receiver side due to digital and analog path delays. Therefore, the technology disclosed herein can be implemented to compensate for these phase and frequency errors and to find symbol timing. Thus, at operation 506, the digital receiver performs a symbol timing synchronization 410, and at operation 508 frequency and offset phase compensation 412. Once symbol timing is recovered and frequency and phase offset errors compensated for, at operation 512, the corrected baseband signal s(n) is demodulated by demodulator 422. Prior to demodulation, a preamble correlator 420 can be implemented to detect, at operation 510, the preamble sequence and identify the start of the frame.

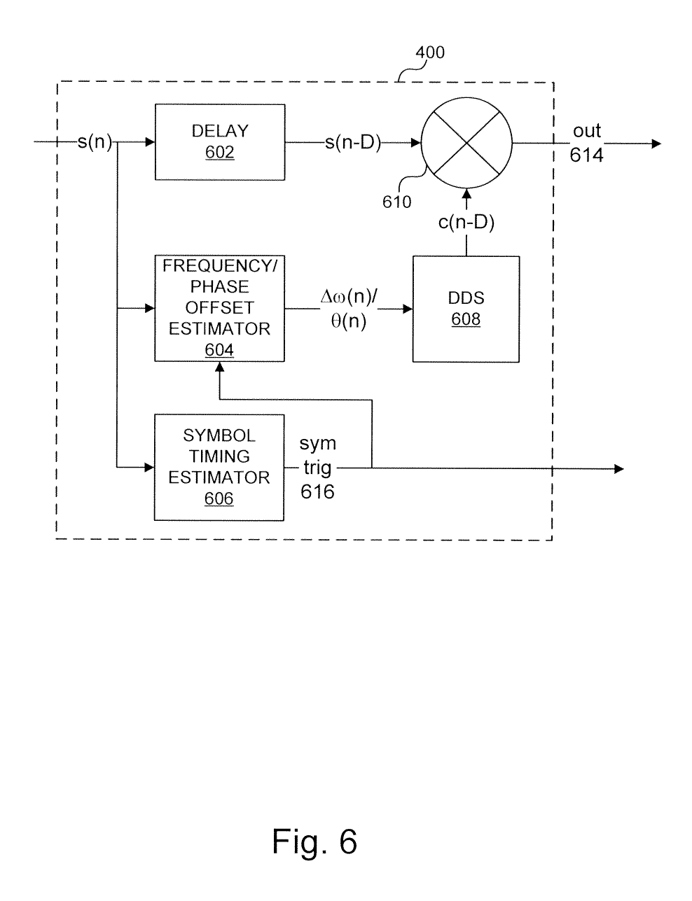

FIG. 6 is a diagram illustrating one example implementation for frequency and phase offset compensation with symbol timing recovery 400 in accordance with one embodiment of the technology described herein. This example implementation shown in FIG. 6 includes a delay block 602, the symbol timing estimator 606, a frequency/phase offset estimator 604, a direct digital synthesizer (DDS) 608, and a mixer 610. Because this can be implemented in the digital domain, the phase and frequency offset compensation and symbol timing estimation can be accomplished using a processing system that may include, for example, digital signal processors executing program code or circuits to perform the described functions.

In various embodiments, frequency/phase offset estimator 604 can be configured to produce an estimate of the frequency offset Δω and/or phase estimate θ of the Incoming signal. These Δω, θ estimates can be used by direct digital synthesizer (DDS) 608 to generate a correction signal c(n−D). This correction signal c(n−D) can be applied at mixer 610 to remove the determined frequency and phase offsets. In the illustrated example, the correction signal c(n−D) is applied to a delayed version of received signal, s(n−D), which is created by delay module 602. This delay D is used to compensate for processing time. A symbol trigger can be used to synchronize frequency/phase estimators with the received signal. It can be used by a preamble correlator and demodulator as well. Symbol timing estimator 606 can be used to generate a symbol trigger “sym trig” (e.g., a strobe) to indicate the start of a symbol. Accordingly, at the output is a phase/frequency corrected output signal 614 and a symbol timing signal, sym trig 616.

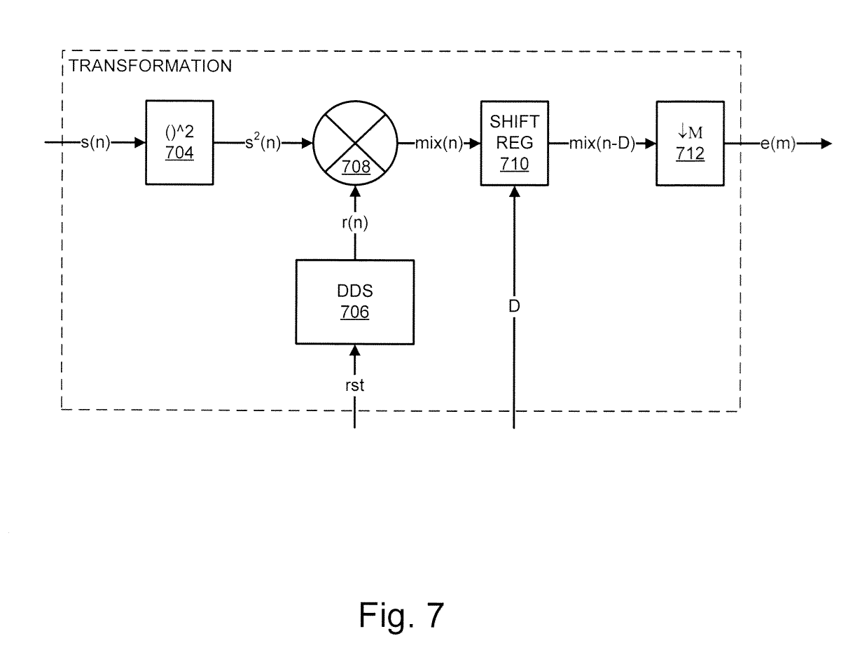

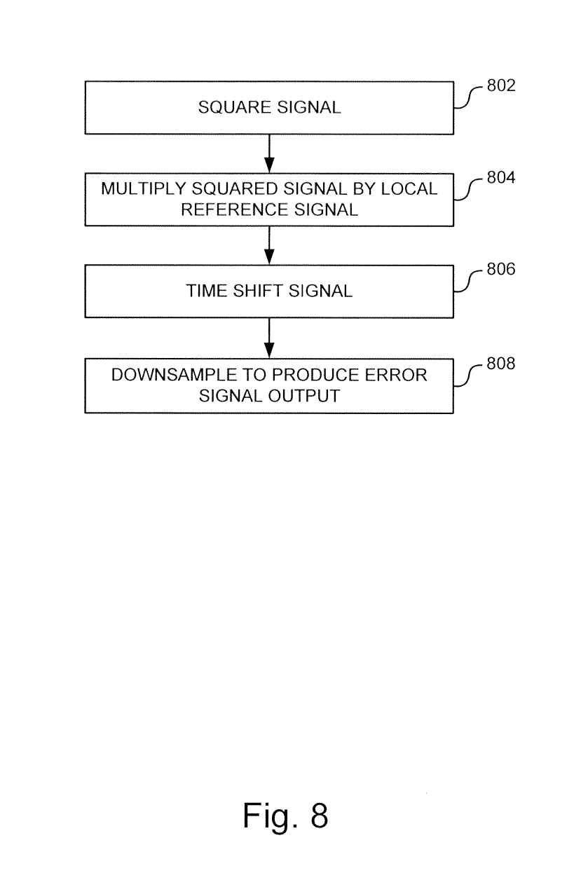

FIG. 7 is a diagram illustrating an example transformation that can be performed in accordance with various embodiments of the technology disclosed herein. FIG. 8, is an operational flow diagram illustrating a process performed by this transformation module. Referring now to FIGS. 7 and 8, at operation 802 the modulated signal s(n) is received and squared by squaring module 704. This results in a squared modulated signal s²(n). Direct digital synthesizer DDS 706 can be configured to, for example, generate, or synthesize, a frequency and phase-tunable output signal referenced to a frequency source. In this example, DDS 706 can be configured to generate a reference signal r(n), which is a complex exponential signal at two times the modulating frequency ω. Reference signal r(n) can be reset by a system reset signal rst.

At operation 804, the squared signal s²(n) is multiplied by the local reference signal r(n) using complex multiplier 708, resulting in signal mix(n). That operation shifts spectrum components of squared signal by 2ω.

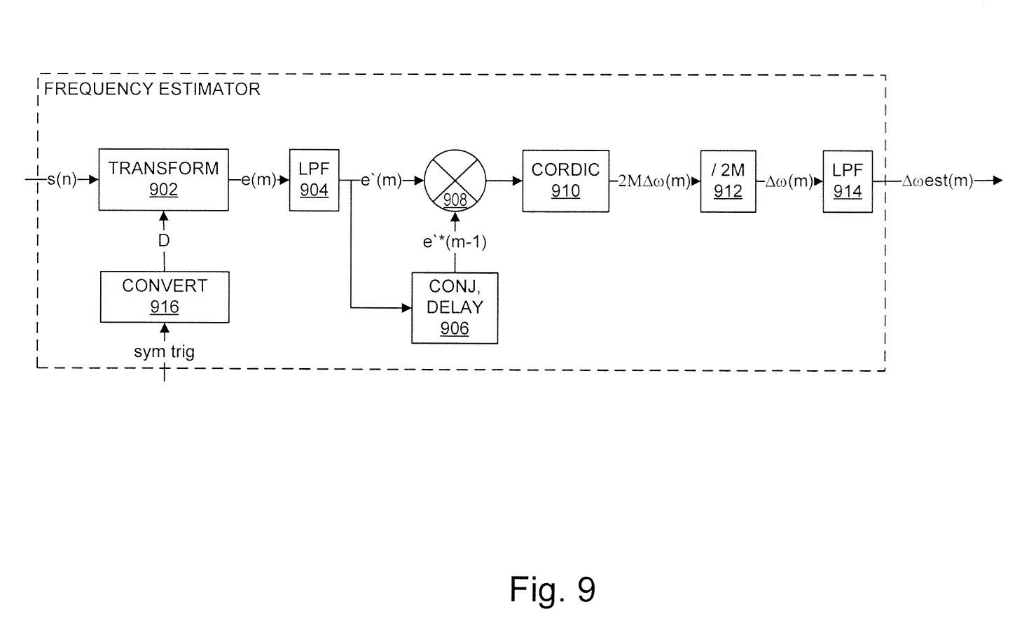

At operation 806 the signal mix(n) is time shifted or delayed, which can be accomplished using a shift register 710 with a delay input D. Particularly, the signal can be shifted by D (0≦D<M), resulting in time-shifted signal mix(n−D). This time-shifted signal is down sampled by M=f_{S}/R at operation 808. In various embodiments, delay input D is generated from sym trig 616, for example, as described below with reference to FIG. 9.

In the illustrated example, downsampling is accomplished using downsampler 712 to produce error signal e(m) at the output, where f_{S} is a sampling frequency and R is a symbol rate. Typically, for a digital-IF receiver, f_{IF}=f_{S}/4, f_{S}=8R and then M=8. Time shifting the signal with shift register 710 provides the opportunity to select which sample from a stream of samples is chosen by the downsampler 712.

Mathematically, the transform illustrated in FIG. 7 can be rewritten as shown in equation 1.

$${s}_{k , i} - {( - 1 )}^{{φ}_{k}} {e}^{j \{ {( - 1 )}^{{b}_{k}} ω T [ k + \frac{i}{M} + ɛ ] + Δω T [ k + \frac{t}{M} ] + {θ}_{0} \}} \qquad ( 1 )$$

Eq. (1) shows that the MSK signal, s_{k,i}, is oversampled by M, where:

$${φ}_{k} = {a}_{2 ⌊ \frac{k}{2} ⌋} = {a}_{even} - even$$

data bit of modulating data sequence aₖε(0,1);

$${b}_{k} = xnor ( {a}_{2 ⌊ \frac{k}{2} ⌋} , {a}_{2 ⌈ \frac{k}{2} ⌉ - 1} ) = xnor ( {a}_{even} , {a}_{odd} ) - {b}_{k}$$

is the result of an exclusive OR inverse operation that depends on both even and odd bits;

T=1/R is the symbol period;

$$ω = \frac{π}{2 T}$$

is the modulating frequency;

i and M are a fraction of the symbol time 0≦i<M and the symbol oversampling rate M, respectively;

ε is the timing error relative to T, 0.5≦ε≦0.5; and

Δω and θ₀ are the frequency offset error and initial phase error, respectively.

The squaring operation, which in this case is nonlinear, produces the signal as shown in Eq. (2).

$${s}_{k , l}^{2} = {e}^{2 j \{ {( - 1 )}^{{b}_{k}} ω T [ k + \frac{i}{M} + ɛ ] + Δω T [ k + \frac{i}{M} ] + {θ}_{0} \}} \qquad ( 2 )$$

As a result of mixing with the local reference signal

$${r}_{k , i} = {e}^{2 j \{ ω T [ k + \frac{i}{M} ] \}}$$

at mixer 708, the signal mix_{k,i} can be as shown in Eq. (3), where the new parameter cₖ=2(1−bₖ)ε(0,2).

$${mix}_{k , i} = {s}_{k , i}^{2} {r}_{k , i} = {e}^{2 j \{ {ɛ}_{k} ω T [ k + \frac{i}{M} ] \}} {e}^{2 j \{ {( - 1 )}^{{b}_{{k}_{ω T ɛ}}} + Δω T [ k + \frac{i}{M} ] + {θ}_{0} \}} \qquad ( 3 )$$

Lastly, downsampling by M of signal mix(n−D) delayed by shift register 710, as shown at operation 806 and 808, folds the high-frequency frequency component e^{2j(2ωTk)}=e^{j2πk}=1, when cₖ=2 and output e(m), where m=k is simplified to Eq. (4):

$$e ( m ) = mix ( \frac{n - D}{M} ) = {e}^{2 j \{ {( - 1 )}^{{b}_{m}} ω T ɛ + Δω Tm + {θ}_{0} \}} \qquad ( 4 )$$

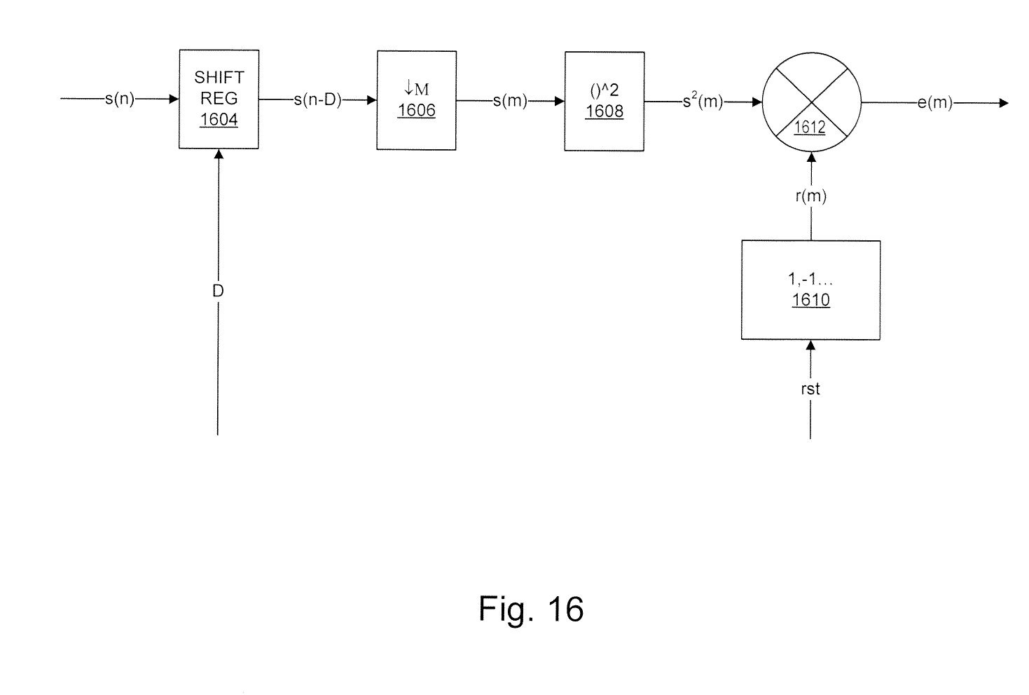

Note that, downsampling can be done prior all other operations and digital circuit can work at m=n/M clock rate that significantly simplifies implementation as shown on FIG. 16.

As described above, three blocks or modules provided herein include a symbol timing generator, a frequency estimator frequency estimator and a phase estimator. An example of these in combination is shown in FIG. 6, in which the symbol timing estimator is shown at 606, and the frequency and phase offset estimator is shown at 604. Examples of these blocks are now described.

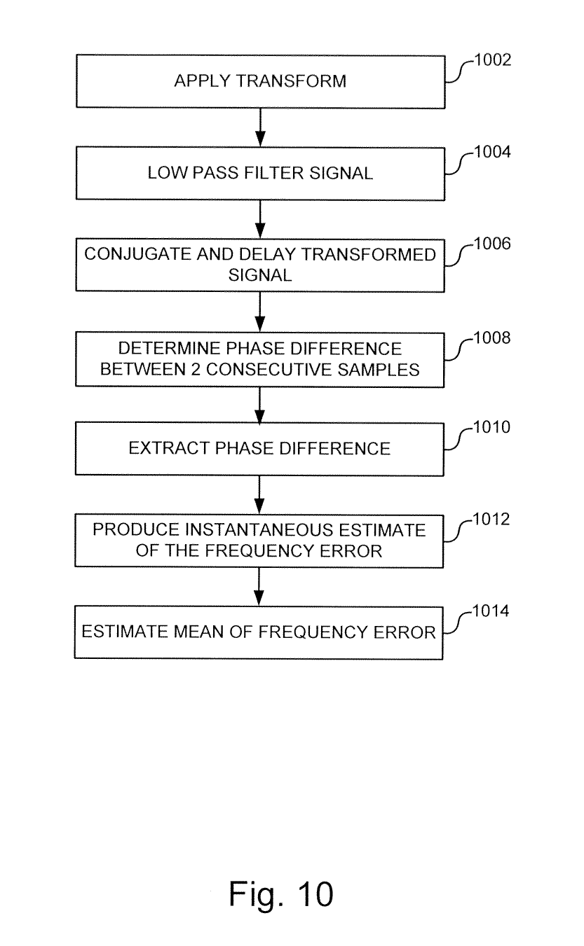

FIG. 9 is a diagram illustrating an example block for performing frequency estimation in accordance with various embodiments of the technology disclosed herein. FIG. 10 is an operational flow diagram illustrating an example process for frequency estimation in accordance with various embodiments of the technology disclosed herein. Referring now to FIGS. 9 and 10, the example frequency estimator includes a transform block 902, a filtering block 904, a conjugate/delay block 906, a mixer 908, a CORDIC 910, a divider 912, low pass filter 914 and converter 916. In operation, the modulated signal (e.g. an MSK modulated signal) s(n) is received by the frequency estimator. At operation 1002, transform module 902 applies a transform, which can be keyed based on a sym trig (e.g., sym trig 616).

That symbol trigger signal can be converted into delay D by converter 916 for transform 902. The conversion can be accomplished, for example, by determining which of M clocks contains a symbol trigger set to one. The resultant delay D (0≦D<M) is provided to transform 902.

This results in the creation of an error signal e(m) at the output of transform block 902. At operation 1004, low pass filter block 904 filters the signal to remove high-frequency noise, resulting in filtered error signal e′(m). At operation 1006, conjugate/delay block 906 conjugate and delays the transformed filtered signal, and at operation 1008 the transform signal and the delayed transformed signal are multiplied at mixer 908 to determine the phase difference between two consecutive samples.

At operation 1010, CORDIC block 910 extracts the phase. In some embodiments, this is accomplished by converting from x,y coordinates to polar coordinates (amplitude and phase) to determine the phase differential by other methods. Accordingly, this results in signal 2MΔω(m). This signal, is 2M larger due to the squaring and downsampling that occur in the transform (see FIG. 7 for example). Accordingly, at operation 1012, the frequency offset is divided by 2M and the system produces an instantaneous estimate of frequency error Δω(m). After that at operation 1014, the estimator estimates a mean of the frequency error. In one embodiment, this can be accomplished using a low pass filter 914, which can be implemented as an infinite impulse response (IIR) filter or finite impulse response (FIR) filter. This can be implemented to continuously track the mean of the frequency error Δωₑₛₜ(m).

The system can also be configured to determine the phase offset. After the system performs a frequency offset determination, the determined frequency may still have some mismatch to the true frequency. Any such mismatch will result in a phase error that accumulates over time. Therefore, the system can be configured to not only estimate the initial phase, but also to estimate the residual phase error resulting from frequency offset mismatch.

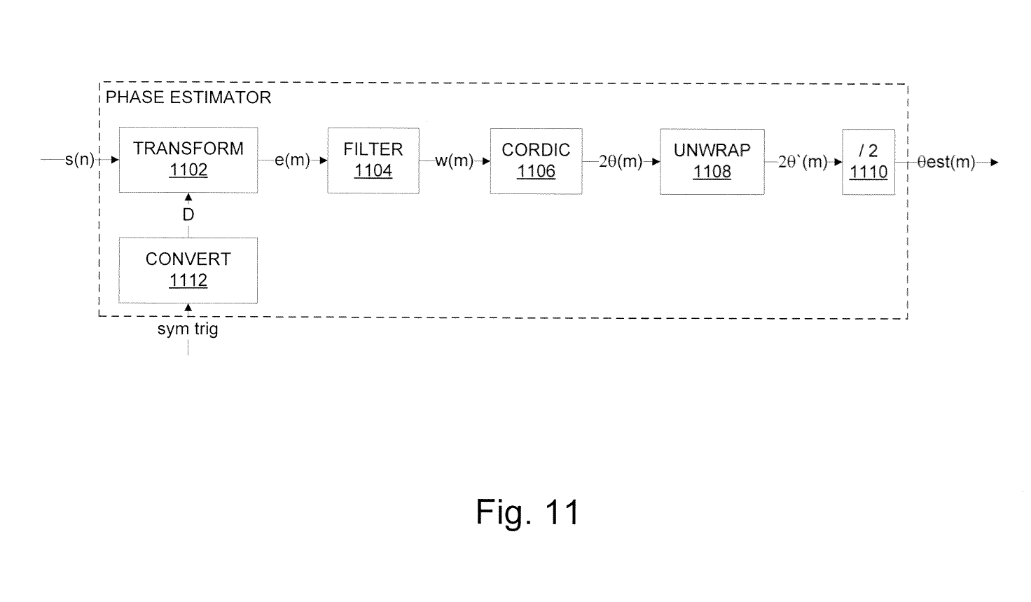

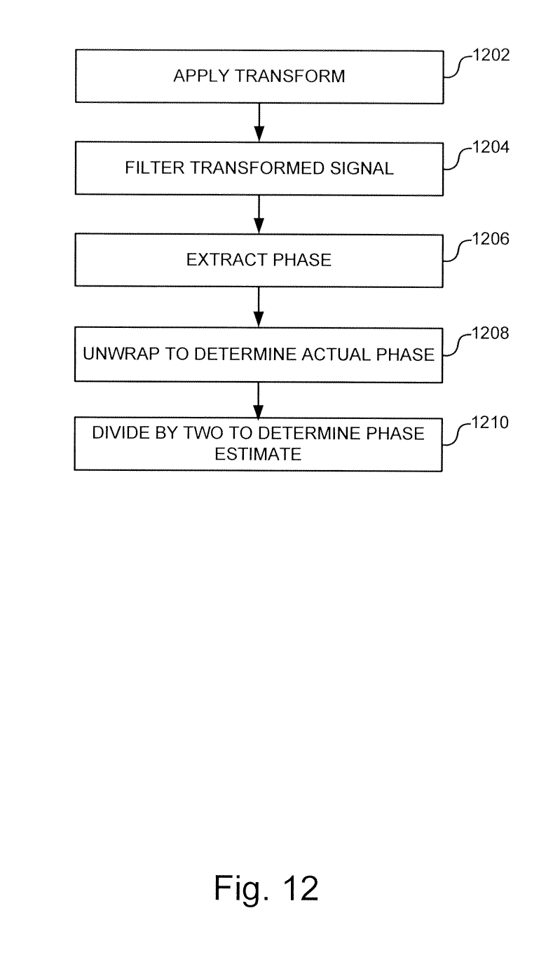

FIG. 11 is a diagram illustrating an example of a phase estimator block for estimating residual phase error in accordance with one embodiment of the technology described herein. The example phase estimator block depicted at FIG. 11 estimates phase error θ(m), which includes an initial phase error θ₀ and a phase error θ_{f}(m) produced by residual frequency error Δωᵣₑₛ(m)=Δωₑₛₜ(m)−Δωₜᵣᵤₑ(m). It is presumed in various embodiments that frequency error is already corrected, and therefore there is only small residual error present at the input of the phase estimator. FIG. 12 is an operational flow diagram illustrating an example process for phase offset estimation in accordance with one embodiment of the technology described herein. Referring now to FIGS. 11 and 12, at operation 1202 the phase estimator block applies transform 1102. One example of a transform 1102 they can be applied is the transform described above with reference to FIG. 7.

At operation 1204, the transformed signal e(m) is filtered by filter 1104. Filter 1104 can be configured to average instantaneous phase errors prior to phase extraction using CORDIC 1106. In various embodiments, this operation can be performed using a simple LMS-like (least mean square) adaptive filter, or other type of filter that is capable of estimating an average of the instantaneous phases. In various embodiments, filtering is performed before the CORDIC, because the CORDIC produces −π to π phase, and noise will cause this output to wrap the instantaneous phase.

At operation 1206 the mean of the phase offset is extracted. In some embodiments, this can be performed by a CORDIC operation. The CORDIC 1106 produces two times the phase error θ(m) that can be unwrapped using simple logic. At operation 1208, the estimator unwraps this phase error to track the accumulated phase offset. Because there is a residual phase offset, the phase ultimately wraps at π or −π points (the phase of complex numbers defined from π to −π). At operation 1210, the estimator divides by two to determine the phase estimate. Division by two after unwrapping gives phase error θₑₛₜ(m) of interest.

Symbol timing recovery is used to determine the timing, or clock of the transmitted symbols. To do symbol timing recovery, the system can be configured to take the incoming signal and set different delays, D from 0 to M−1, and to apply these as transform delays. A polyphase dock can be used to provide multiple phases to the delay blocks to apply the different delays. The output of this block is used to generate symbol trigger signal “sym trig” for the frequency/phase estimator so that it may synchronize the received signal with the local reference free running DDS, which may be reset by some arbitrary reset signal “rst”.

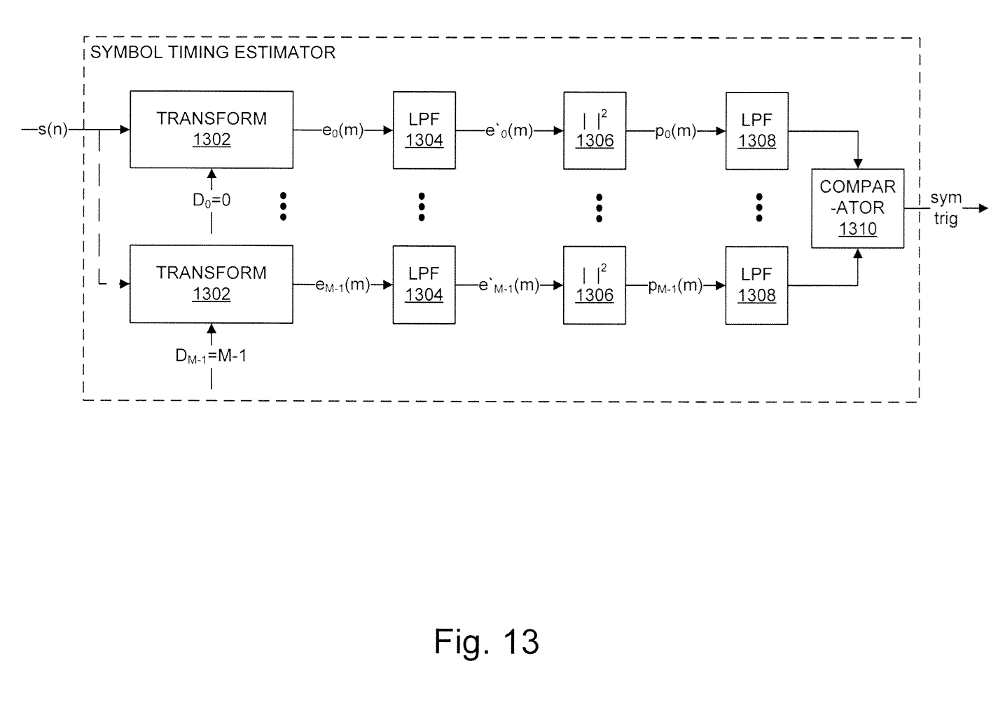

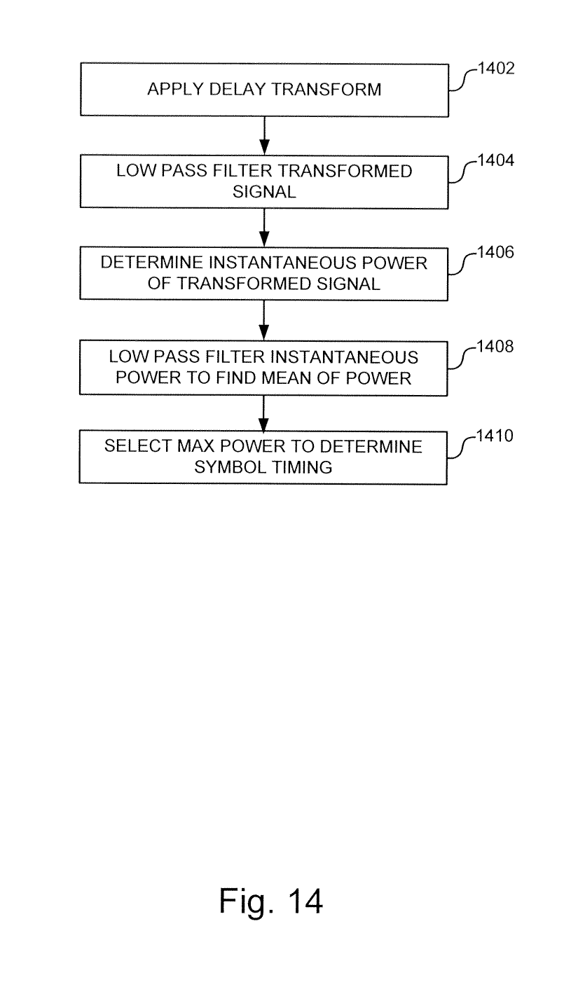

FIG. 13 is a diagram illustrating an example block for performing symbol timing recovery in accordance with various embodiments of the technology disclosed herein. FIG. 14 is an operational flow diagram illustrating an example process for symbol timing recovery in accordance with various embodiments of the technology disclosed herein. Referring now to FIGS. 13 and 14, the example shows a plurality of delays 1302. In the illustrated example, M delay transforms with D=0 . . . M−1, are contemplated. The example symbol timing estimator block shown in FIG. 13 recovers symbol timing information with 1/M clock precision.

Accordingly, this block consists of M processing units each working at a clock rate of m=n/M, and a comparator 1310 at the end that generates “sym trig” symbol trigger signal. The time-shift value D of each transform unit is equal to 0 . . . M−1.

At operation 1404, low pass filters can be employed to filter out high frequency noise, and they can be implemented as an IIR or other appropriate low pass filter. This can be useful, for example, to remove the additive white Gaussian noise (AWGN) on the signal.

At operation 1406, the instantaneous power of the filtered error signal is calculated. This is performed by blocks 1306. At operation 1408, the symbol timing estimator determines the mean power by low pass filtering instantaneous power. In this example, low pass filters are implemented as FIR filters or IIR filters to find the mean power. At operation 1410, the maximum power signal is selected to determine symbol timing. In the illustrated example, a comparator 1310 can be used to compare the mean power from each of the related branches to determine which one has the maximum power. The system selects the branch with the maximum power, and its associated delay is identified. The maximum power output points out the delay D between the received signal and local reference signal to recover symbol timing. In various embodiments, docks at different phases (e.g., separate clocks, or a polyphase clock) are used to trigger delay transforms 1302.

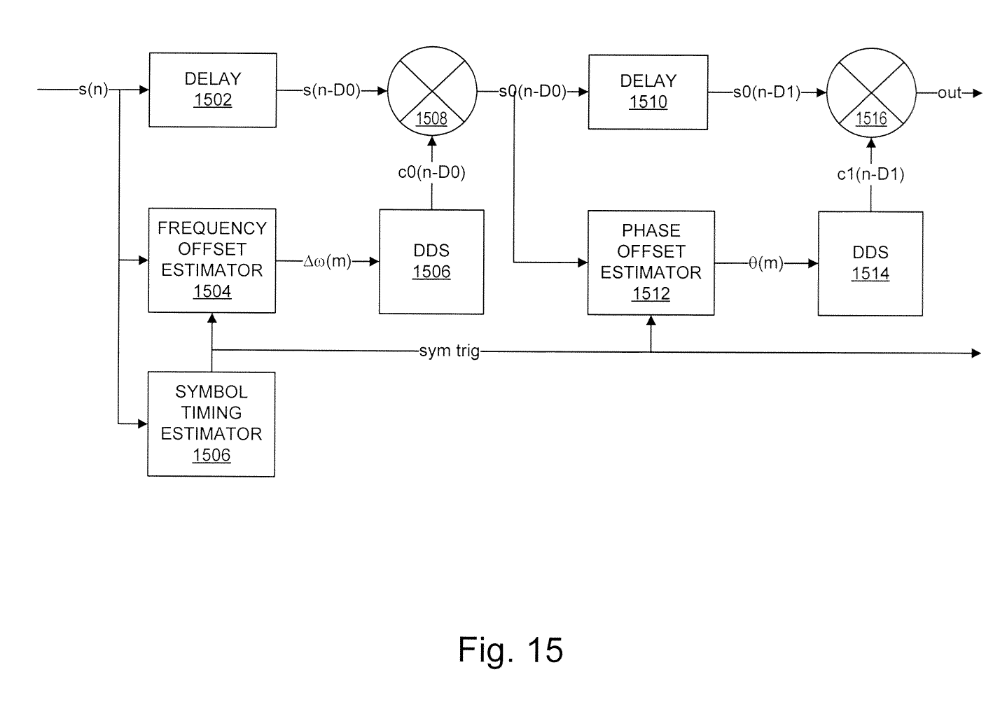

As described above with reference to FIG. 6, a symbol timing estimator and frequency and phase offset estimators can be used to perform the desired timing, frequency and phase estimation. Described above or example embodiments for a frequency estimator, a phase estimator, and a symbol timing estimator they can be used with such a system. FIG. 15 is a block diagram illustrating an example architecture of a system for frequency and phase estimation with symbol timing recovery in accordance with one embodiment of the technology described herein.

As seen in FIG. 15, an example implementation includes a delay blocks 1502, 1510, a frequency offset estimator 1504, a symbol timing estimator 1506, a DDS 1508, mixers 1516 and 1518, a phase-offset estimator 1512, and a DDS block 1514. As this more detailed example illustrates, frequency offset estimation 1504 and phase offset estimation 1512 can be performed separately. Particularly, in this example, frequency offset estimation is performed before phase offset estimation. As this example also illustrates symbol timing estimation can be used to generate the trigger signal sym trig that is used to trigger frequency-offset estimator 1504 and phase-offset estimator 1512. In various embodiments, frequency offset estimator 1504 can be implemented, for example, using frequency offset estimator 900 as described above. DDS 1508 can be configured to provide the appropriate correction signal to make sure 1518 to remove the frequency offset. Because there may still be some frequency mismatch, phase offset estimator 1512 can be used to remove any additional phase offset created by this mismatch. In various embodiments, phase offset estimator 1512 can be implemented, for example, using phase offset estimator 1100 as described above. Phase offset estimator 1512 can be configured to output an estimate of the phase offset to DDS 1514 such that mixer 1516 can apply the correction removing the phase offset from the signal.

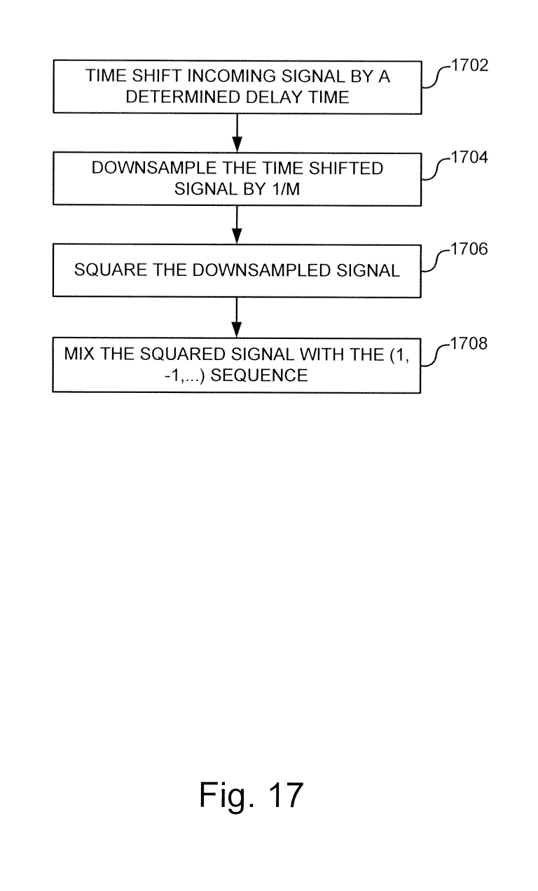

As described herein the transformation can be used to provide an estimate e(m) for the operations described herein. The embodiment illustrated in FIGS. 7 and 8, however, is not the only embodiment that can be used for this transformation 700. For example, FIG. 16 is a block diagram illustrating another example transformation in accordance with one embodiment of the technology disclosed herein. FIG. 17 is a diagram illustrating an operational flow diagram for this transformation in accordance with one embodiment of the technology disclosed herein.

Referring now to FIGS. 16 and 17, at operation 1702 the incoming signal s(n) is time shifted or delayed. In this example, a shift register 1604 is provided at the beginning of the transformation to introduce delay into the incoming signal s(n), resulting in delayed signal s(n−D). As with the embodiment described above with reference to FIG. 7, the signal s(n) can be shifted by D (0≦D<M), resulting in time-shifted signal s(n−D). Time shifting the signal with shift register provides the opportunity to select which sample from a stream of samples is chosen by the downsampling (discussed below).

At operation 1704, the time-shifted signal s(n−D) is downsampled by M=f_{S}/R, where f_{S} is a sampling frequency and R is the symbol rate. In the illustrated example, downsampling is accomplished by downsampling block 1606 to produce downsampled signal s(m) at the output. As can be seen by comparing the embodiment of FIGS. 16 and 17 with that of FIGS. 7 and 8, the introduction of the delay and the downsampling are moved to an earlier point in the transformation. Moving the downsampling earlier in the transformation allows the remainder of the operations to be performed at a slower rate. For example, for a typical digital-IF receiver, f_{IF}=f_{S}/4, f_{S}=8R and then M=8. This can ease the cost and complexity of the operation.

At operation 1706, the downsampled the signal is squared by block 1608. This results in the squared downsampled signal s²(m). At operation 1708, mixer 1612 is used to combine the squared output s²(m) with r(m) from the DDS 1610. This can be done by a complex multiplication of the two signals. In various embodiments, reference signal r(m) is at fₛ/2, therefore, the DDS 1610 can be simplified to [1, −1, . . . ] real-valued sequence and hence complex multiplication replaced by two real multiplications with a [1, −1 . . . ] sequence.

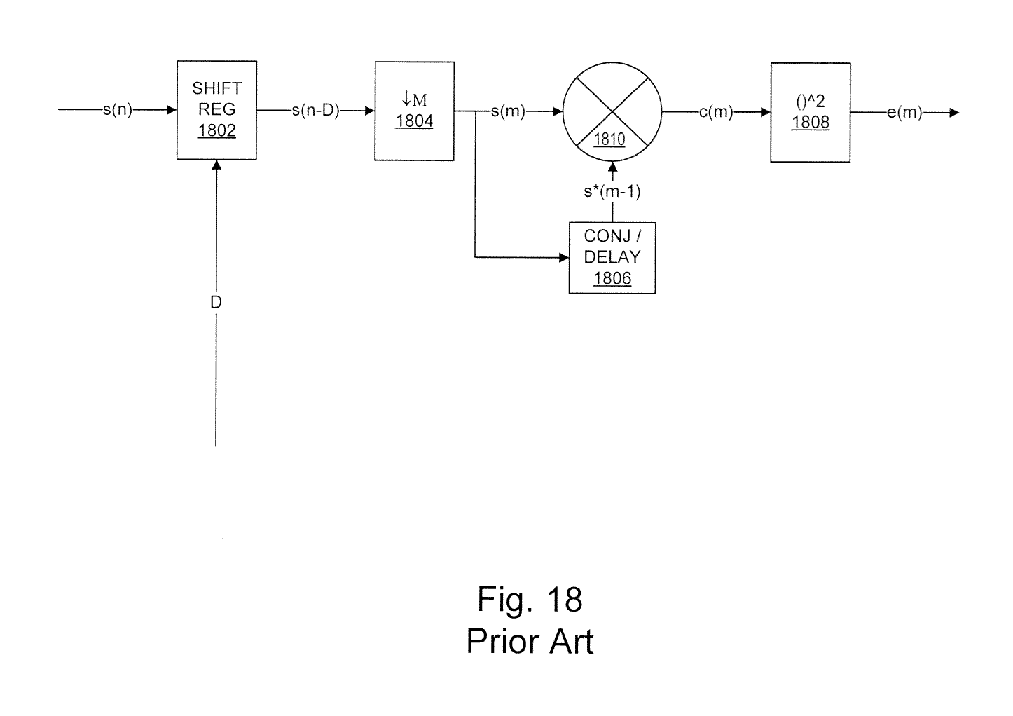

This embodiment and the embodiment illustrated in FIGS. 7 and 8 can be compared to the prior art transformation described by the Mehlan Reference, as shown in FIG. 18. Referring now to FIG. 18, the Mehlan transformation 1800 includes operations of shifting the incoming signal and downsampling the shifted signal as illustrated at blocks 1802 and 1804. Then, the transformation 1800 multiplies (through complex multiplication) the downsampled signal s(m) with the delayed conjugate of the signal, s*(m−1), produced by conjugate/delay block 1806. The resultant signal, c(m), is then squared by block 1808. This is in contrast to the embodiments described above in which the squaring is performed before multiplication by the DDS output.

As described above, the system described by the Mehlan Reference finds the error signal expectation as:

E{e(m)}=(1+cos 2πε))e^{2jΔwT}.

Whereas, in contrast, in embodiments described herein, the error signal is

e(m)=e^{2j{(-1)}^{^{b}}^{mωTε+ΔωTm+θ}^{₀}},

in which the ε component represents the symbol timing, the Δω component represents the frequency offset estimate, and the θ₀ component represents the phase offset.

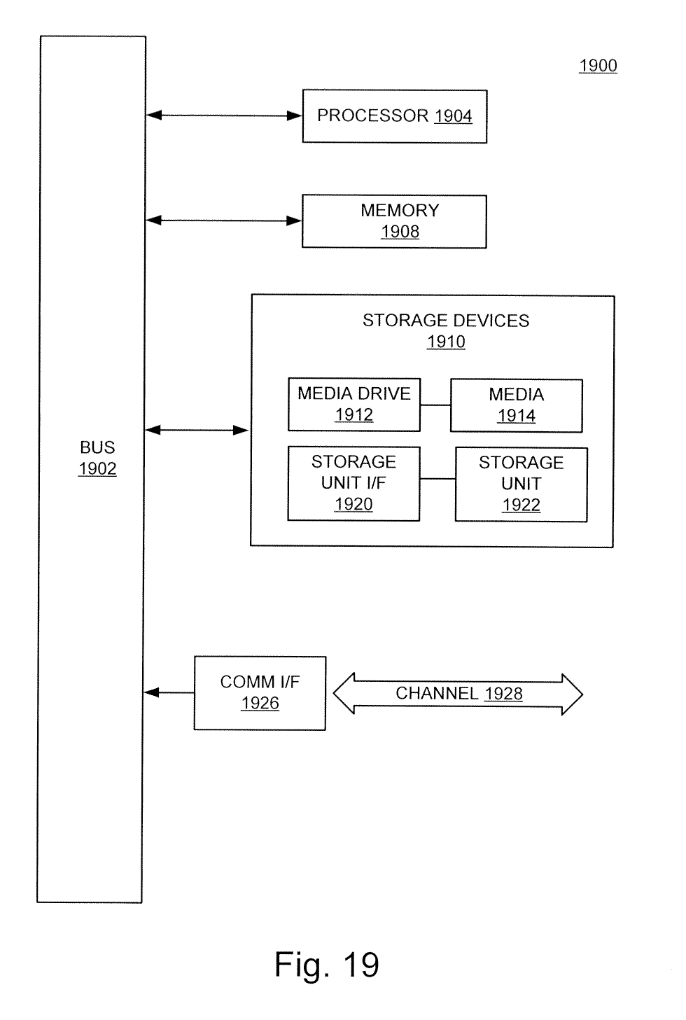

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 19. Various embodiments are described in terms of this example—computing module 1900. After reading this description, it will become apparent to a person skilled in the relevant art how to implement the technology using other computing modules or architectures.

Referring now to FIG. 19, computing module 1900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 1900 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1900 might include, for example, one or more processors, controllers, control modules, or other processing devices, such as a processor 1904. Processor 1904 might be implemented using a general-purpose or special-purpose processing engine such as, for example, a microprocessor, controller, or other control logic. In the illustrated example, processor 1904 is connected to a bus 1902, although any communication medium can be used to facilitate interaction with other components of computing module 1900 or to communicate externally.

Computing module 1900 might also include one or more memory modules, simply referred to herein as main memory 1908. For example, preferably random access memory (RAM) or other dynamic memory, might be used for storing information and instructions to be executed by processor 1904. Main memory 1908 might also be used for storing temporary variables or other intermediate information during execution of instructions to be executed by processor 1904. Computing module 1900 might likewise include a read only memory (“ROM”) or other static storage device coupled to bus 1902 for storing static information and instructions for processor 1904.

The computing module 1900 might also include one or more various forms of information storage mechanism 1910, which might include, for example, a media drive 1912 and a storage unit interface 1920. The media drive 1912 might include a drive or other mechanism to support fixed or removable storage media 1914. For example, a hard disk drive, a floppy disk drive, a magnetic tape drive, an optical disk drive, a CD or DVD drive (R or RW), or other removable or fixed media drive might be provided. Accordingly, storage media 1914 might include, for example, a hard disk, a floppy disk, magnetic tape, cartridge, optical disk, a CD or DVD, or other fixed or removable medium that is read by, written to or accessed by media drive 1912. As these examples illustrate, the storage media 1914 can include a computer usable storage medium having stored therein computer software or data.

In alternative embodiments, Information storage mechanism 1910 might include other similar instrumentalities for allowing computer programs or other instructions or data to be loaded into computing module 1900. Such instrumentalities might include, for example, a fixed or removable storage unit 1922 and an interface 1920. Examples of such storage units 1922 and interfaces 1920 can include a program cartridge and cartridge interface, a removable memory (for example, a flash memory or other removable memory module) and memory slot, a PCMCIA slot and card, and other fixed or removable storage units 1922 and interfaces 1920 that allow software and data to be transferred from the storage unit 1922 to computing module 1900.

Computing module 1900 might also include a communications interface 1924. Communications interface 1924 might be used to allow software and data to be transferred between computing module 1900 and external devices. Examples of communications interface 1924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1924 might typically be carried on signals, which can be electronic, electromagnetic (which includes optical) or other signals capable of being exchanged by a given communications interface 1924. These signals might be provided to communications interface 1924 via a channel 1928. This channel 1928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1908, storage unit 1920, media 1914, and channel 1928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1900 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A radio frequency receiver configured to receive a modulated signal transmitted across a channel, the radio frequency receiver comprising:
a first transformation module configured to generate a first error signal for an information signal representing the modulated signal received by the receiver, the transformation module comprising:
a squaring module configured to square the information signal, thereby generating a squared signal; and
a first mixer configured to perform a complex multiplication of the squared signal by a local reference signal;
a symbol timing estimator module, configured to estimate a symbol timing of the receive signal based on the error signal generated by the first transformation module, and to generate a symbol timing signal;
a frequency offset estimator module, configured to estimate a frequency offset of the received signal based on the error signal generated by the transformation module;
a phase offset estimator module configured to estimate a phase error in the received signal based on the error signal generated by the transformation module.

2. The radio frequency receiver of claim 1, wherein the symbol timing estimator module, frequency offset estimator module, and phase offset estimator module are each configured to perform their respective estimation using the error signal calculated based on the same information signal.

3. The radio frequency receiver of claim 1, further comprising a second transformation module, wherein the second transformation module is configured to generate a second error signal for the received signal based on a frequency corrected information signal, and the first transformation module is configured to generate the first error signal based on the information signal; and further wherein the symbol timing estimator module and frequency offset estimator module are configured to perform their respective estimation using the first error signal calculated based on the same received signal, and the and phase offset estimator module is configured to perform phase offset estimation using the second error signal calculated based on the frequency corrected information signal.

4. The radio frequency receiver of claim 1, further comprising a second mixer configured to apply the estimated frequency offset to the information signal resulting in a frequency corrected information signal, and a third mixer configured to apply the estimated phase offset to the frequency corrected information signal.

5. The radio frequency receiver of claim 1, wherein the transform module further comprises a shift register module configured to receive an output signal from the mixer and to delay the output signal; and a downsampler configured to perform spectrum folding of the mixed, delayed signal in order to select delayed samples of the output error signal.

6. The radio frequency receiver of claim 1, wherein the transform module further comprises a shift register module configured to delay the information signal, and a downsampler module configured to down sample the delayed information signal prior to squaring, and wherein squaring the information signal comprises squaring the downsampled delayed information signal.

7. The radio frequency receiver of claim 1, wherein in the information signal comprises a digitized and downconverted version of the modulated signal received by the receiver.

8. The radio frequency receiver of claim 7, wherein the transformation, symbol timing estimator, frequency offset estimator and phase offset estimator modules comprise computer readable program code stored on a non-transitory storage medium.

9. The radio frequency receiver of claim 1, wherein the information signal comprises a digital baseband signal.

10. The radio frequency receiver of claim 1, wherein the error signal generated by the first transformation module comprises:
e(m)=e^{2j{(-1)}^{^{b}}^{mωTε+ΔωTm+θ}^{₀}^{}},
wherein the ε component represents the symbol timing estimate, the Δω component represents the frequency offset estimate, and the θ₀ component represents the phase offset estimate.

11. The radio frequency receiver of claim 1, wherein estimating symbol timing by the symbol timing estimator module comprises performing a plurality of transformations, each transformation operating on a version of the information signal delayed by a different amount, comparing results of the plurality of transformations, and determining, based on the comparison, which amount of delay represents the delay between the received signal and local reference signal.

12. The radio frequency receiver of claim 11, wherein comparing comprises comparing mean power from each of the plurality of transformations to determine which one has the maximum power. The system selects the branch with the maximum power, and its associated delay is identified. The maximum power output points out the delay D between the received signal and local reference signal to recover symbol timing.

13. A method for estimating frequency and phase offset and symbol timing for a modulated signal transmitted across a channel and received by a receiver, the method comprising:
applying a first transformation to an information signal representing the modulated signal received by the receiver to generate a first error signal, wherein the transformation comprises squaring the information signal, thereby generating a squared signal, and multiplying by complex multiplication the squared signal by a reference signal;
estimating a symbol timing of the received signal based on the error signal generated by the first transformation, and generating a symbol timing signal for the information signal;
estimating a frequency offset of the received signal based on the error signal generated by the transformation; and
estimating a phase error in the received signal based on the error signal generated by the transformation.

14. The method of claim 13, wherein estimating the symbol timing, frequency offset, and phase offset are performed using the error signal calculated based on the same information signal.

15. The method of claim 13, further comprising applying a second transformation that generates a second error signal for the received signal based on a frequency corrected information signal, and the first transformation generates the first error signal based on the information signal; and further wherein estimating the symbol timing and frequency offset are performed using the first error signal calculated based on the same received signal, and the and estimating the phase offset is performed using the second error signal calculated based on the frequency corrected information signal.

16. The method of claim 13, further comprising mixing the estimated frequency offset with the information signal resulting in a frequency corrected information signal, and mixing the estimated phase offset with the frequency corrected information signal resulting in a corrected information signal.

17. The method of claim 13, wherein the transformation further comprises delaying a signal output from the multiplication and down sampling the delayed signal to generate the error signal.

18. The method of claim 13, wherein the transformation further comprises delaying the information signal, and down sampling the delayed information signal prior to squaring, and wherein squaring the information signal comprises squaring the downsampled delayed information signal.

19. The method of claim 13, wherein in the information signal comprises a digitized and downconverted version of the modulated signal received by the receiver.

20. The method of claim 13, wherein the information signal comprises a digital basedband signal.

21. The method of claim 13, wherein the error signal generated by the first transformation module comprises:
e(m)=e^{2j{(-1)}^{^{b}}^{mωTε+ΔωTm+θ}^{₀}^{}},
wherein the ε component represents the symbol timing estimate, the Δω component represents the frequency offset estimate, and the θ₀ component represents the phase offset estimate.

22. The method of claim 13, wherein estimating symbol timing by the symbol timing estimator module comprises performing a plurality of transformations, each transformation operating on a version of the information signal delayed by a different amount, comparing results of the plurality of transformations, and determining, based on the comparison, which amount of delay represents the delay between the received signal and local reference signal.

23. The method of claim 22, wherein comparing comprises comparing mean power from each of the plurality of transformations to determine which one has the maximum power. The system selects the branch with the maximum power, and its associated delay is identified. The maximum power output points out the delay D between the received signal and local reference signal to recover symbol timing.
